(19) United States
(12) Patent Application Publication
(10) Pub. No.: US 2019/0249050 A1
(43) Pub. Date: Aug. 15, 2019

(54) PROTEIN-BASED ADHESIVES AND METHODS OF MAKING THE SAME

(71) Applicant: Purdue Research Foundation, West Lafayette, IN (US)

(72) Inventors: Jonathan James Wilker, Lafayette, IN (US); Jessica Kay Roman, West Lafayette, IN (US)

(73) Assignee: Purdue Research Foundation, West Lafayette, IN (US)

(21) Appl. No.: 15/771,445

(22) PCT Filed: Oct. 24, 2016
(86) PCT No.: PCT/US16/58391

§ 371 Date: Apr. 27, 2018

Related U.S. Application Data
(60) Provisional application No. 62/246,833, filed on Oct. 27, 2015.

(51) Int. Cl. C09J 189/00; C09J 11/06

(52) U.S. Cl. CPC C09J 189/00; C08K 5/1535; C09J 11/06

(57) ABSTRACT

Utilizing Maillard reaction, soybean protein and bovine serum albumin-based adhesives are produced through a single step process by adding ascorbic acid and are capable of high strengths on both wood and aluminum substrates. The disclosed method is low cost, non-toxic, requires no prior modifications to the proteins and no additional processing prior to use.

### CROSS-REFERENCE TO RELATED APPLICATIONS

The present application is related to and claims the priority benefit of U.S. Provisional Patent Application Ser. No. 62/246,833, filed on Oct. 27, 2015, the content of which is hereby expressly incorporated by reference in its entirety into the present disclosure.

### STATEMENT OF GOVERNMENT SUPPORT

This invention was made with government support under CHE-0952928 awarded by the National Science Foundation. The government has certain rights in the invention.

### TECHNICAL FIELD

The present disclosure generally relates to adhesives, and in particular to methods and compositions of protein-based, non-toxic adhesives.

### INTRODUCTION

This section introduces aspects that may help facilitate a better understanding of the disclosure. Accordingly, these statements are to be read in this light and are not to be understood as admissions about what is or is not prior art.

Adhesives are a major commercial industry, with the demand for high strength adhesives and sealants expected to rise to 9.8 billion pounds in the United States alone by 2017 (Adhesives and Sealants. Industry Market Research for Business Leaders, Strategists, Decision Makers, 1-8 (2014)). While there are many classes of adhesives, at present, most glues are formaldehyde-based (T. Sellers, Forest Products Journal, 51, 12-22 (2001)). These glues emit massive amounts of the carcinogen formaldehyde not just in their production, but also in their everyday use (International Agency for Research on Cancer. IARC Classifies Formaldehyde as Carcinogenic to Humans (Press Release, June, 2004)). Therefore, the adhesives industry is under pressure to develop environmentally friendly adhesives made from renewable resources. Under this pressure, many have begun looking to the adhesives of the past, before formaldehyde-based adhesives were developed. Until the twentieth century, most adhesives were developed from natural resources, including soybean. Due to the low expense and renewability, soybean-based adhesives are once again drawing interest. Common methods for creating these protein-based adhesives often require extensive protein modification or the introduction of functionalized polymer resins (C. R. Frihart, et al., Proceedings of the International Convention of Society of Wood Science and Technology and United Nations Economic Commission for Europe—Timber Committee, Oct. 11-14, 2010, Geneva, Switzerland). These methods can introduce cost and extensive processing, causing the produced adhesive to be too expensive to replace formaldehyde-based adhesives. Hence, a simple, cost effective method for creating protein-based adhesive could become a major player for those unmet needs in the adhesives market.

### SUMMARY

Described herein is a cost effective method utilizing a type of chemistry similar to that in the browning of food, Maillard reaction, to introduce adhesive properties to proteins. In one embodiment, a method for manufacturing an adhesive compromises adding ascorbic acid to a protein, where the molar ratio of protein to ascorbic acid ranges from about 0.001 to about 100. In another embodiment, a method for increasing adhesive properties of a protein, the method compromises adding ascorbic acid to a protein, where the molar ratio of protein to ascorbic acid ranges from about 0.001 to about 100. In one embodiment, an adhesive is prepared by adding ascorbic acid to a protein, where the molar ratio of protein to ascorbic acid ranges from about 0.001 to about 100. Yet in another embodiment, the protein is a renewable protein. In a preferred embodiment, the protein is soy protein. In another preferred embodiment, the protein is bovine serum albumin. In another embodiment, the protein is a soluble protein. In some embodiments, the adhesive further comprises about 0.01˜10 molar equivalences of ferric salt. In another embodiment, the adhesive further comprises about 0.01˜10 molar equivalences of periodate.

### BRIEF DESCRIPTION OF THE FIGURES

The figures illustrate generally, by way of example, but not by way of limitation, various embodiments discussed in the present disclosure.

FIG. 3.1a shows the effect of various proteins:ascorbic acid ratios upon the lap shear adhesion of bovine serum albumin (BSA) on aluminum and wood adherents.

FIG. 3.1b is a bar graph showing the effect of various proteins:ascorbic acid ratios upon the lap shear adhesion of soy protein isolate on aluminum and wood adherents.

FIG. 3.2a describes lap shear adhesion strength of BSA after undergoing Mailard reaction at different temperature.

FIG. 3.2b shows lap shear adhesion strength of soy protein isolate after undergoing Mailard reaction at different temperature.

FIG. 3.3a shows the effect of the amount of time allowed for Mailard reaction to induce protein-protein crosslinking in BSA (note: this is not the curing time).

FIG. 3.3b is a bar graph showing the effect of the amount of time allowed for Mailard reaction to induce protein-protein crosslinking in soy protein isolate (note: this is not the curing time).

FIG. 3.4a describes lap shear adhesion strength of BSA at different concentrations following Mailard reaction.

FIG. 3.4b shows lap shear adhesion strength of soy protein isolate at different concentrations following Mailard reaction.

FIG. 3.5a describes lap shear adhesion strength of soy protein isolate on aluminum after undergoing Mailard reaction at different concentrations of ferric salt in the presence or absence of ascorbic acid.

FIG. 3.5b shows lap shear adhesion strength of soy protein isolate on wood after undergoing Mailard reaction at different concentrations of ferric salt in the presence or absence of ascorbic acid.

FIG. 3.5c describes lap shear adhesion strength of soy protein isolate on aluminum after undergoing Mailard reaction at different concentrations of ferrous salt in the presence or absence of ascorbic acid.

FIG. 3.5d shows lap shear adhesion strength of soy protein isolate on wood after undergoing Mailard reaction at different concentrations of ferrous salt in the presence or absence of ascorbic acid.

FIG. 3.5e describes lap shear adhesion strength of soy protein isolate on aluminum after undergoing Mailard reaction at different concentrations of cupper salt in the presence or absence of ascorbic acid.

FIG. 3.5f shows lap shear adhesion strength of soy protein isolate on wood after undergoing Mailard reaction at different concentrations of cupper salt in the presence or absence of ascorbic acid.

FIG. 3.6a describes lap shear adhesion strength of soy protein isolate on aluminum after undergoing Mailard reaction at different concentrations of sodium salt in the presence or absence of ascorbic acid.

FIG. 3.6b shows lap shear adhesion strength of soy protein isolate on wood after undergoing Mailard reaction at different concentrations of sodium salt in the presence or absence of ascorbic acid.

FIG. 3.6c describes lap shear adhesion strength of soy protein isolate on aluminum after undergoing Mailard reaction at different concentrations of zinc salt in the presence or absence of ascorbic acid.

FIG. 3.6d shows lap shear adhesion strength of soy protein isolate on wood after undergoing Mailard reaction at different concentrations of zinc salt in the presence or absence of ascorbic acid.

FIG. 3.7a describes lap shear adhesion strength of BSA on aluminum after undergoing Mailard reaction at different concentrations of ferric salt in the presence or absence of ascorbic acid.

FIG. 3.7b shows lap shear adhesion strength of BSA on wood after undergoing Mailard reaction at different concentrations of ferric salt in the presence or absence of ascorbic acid.

FIG. 3.7c describes lap shear adhesion strength of BSA on aluminum after undergoing Mailard reaction at different concentrations of ferrous salt in the presence or absence of ascorbic acid.

FIG. 3.7d shows lap shear adhesion strength of BSA on wood after undergoing Mailard reaction at different concentrations of ferrous salt in the presence or absence of ascorbic acid.

FIG. 3.7e describes lap shear adhesion strength of BSA on aluminum after undergoing Mailard reaction at different concentrations of cupper salt in the presence or absence of ascorbic acid.

FIG. 3.7f shows lap shear adhesion strength of BSA on wood after undergoing Mailard reaction at different concentrations of cupper salt in the presence or absence of ascorbic acid.

FIG. 3.8a describes lap shear adhesion strength of BSA on aluminum after undergoing Mailard reaction at different concentrations of sodium salt in the presence or absence of ascorbic acid.

FIG. 3.8b shows lap shear adhesion strength of BSA on wood after undergoing Mailard reaction at different concentrations of sodium salt in the presence or absence of ascorbic acid.

FIG. 3.8c describes lap shear adhesion strength of BSA on aluminum after undergoing Mailard reaction at different concentrations of zinc salt in the presence or absence of ascorbic acid.

FIG. 3.8d shows lap shear adhesion strength of BSA on wood after undergoing Mailard reaction at different concentrations of zinc salt in the presence or absence of ascorbic acid.

FIG. 3.9a describes lap shear adhesion strength of soy protein isolate on aluminum and wood after undergoing Mailard reaction at different concentrations of periodate in the presence or absence of ascorbic acid.

FIG. 3.9b shows lap shear adhesion strength of BSA on aluminum and wood after undergoing Mailard reaction at different concentrations of periodate in the presence or absence of ascorbic acid.

FIG. 3.10a describes lap shear adhesion strength of soy protein isolate on wood after undergoing Mailard reaction under various curing conditions.

FIG. 3.10b shows lap shear adhesion strength of soy protein isolate on aluminum after undergoing Mailard reaction under various curing conditions.

FIG. 3.11a describes lap shear adhesion strength of BSA on wood after undergoing Mailard reaction under various curing conditions.

FIG. 3.11b shows lap shear adhesion strength of BSA on aluminum after undergoing Mailard reaction under various curing conditions.

FIG. 3.12a shows the comparison of the lap shear adhesion strength of BSA on aluminum after undergoing Mailard reaction with various commercial adhesives under the optimum curing temperature and time for the protein, 95° C. and 3 hours, respectively.

FIG. 3.12b the comparison of the lap shear adhesion strength of BSA on wood after undergoing Mailard reaction with various commercial adhesives under the optimum curing temperature and time for the protein, 95° C. and 3 hours, respectively.

FIG. 3.13 describes the result of amino acid analysis before and after Mailard reaction. The reaction was allowed to proceed for 7 days prior to chromatographic analysis.

FIG. 3.14 shows cases where BSA adhesive was able to break apart the pine wood adherends due to the strong mechanical interlocking of BSA adhesive.

FIG. 3.15a shows the comparison of the lap shear adhesion strength of soy protein isolate on aluminum after undergoing Mailard reaction with various commercial adhesives under the optimum curing temperature and time for the protein, 95° C. and 3 hours, respectively.

FIG. 3.15b the comparison of the lap shear adhesion strength of soy protein isolate on wood after undergoing Mailard reaction with various commercial adhesives under the optimum curing temperature and time for the protein, 95° C. and 3 hours, respectively.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure the term “about” can allow for a degree of variability in a value or range, for example, within 10%, within 5%, or within 1% of a stated value or of a stated limit of a range.

In the present disclosure the term “substantially” can allow for a degree of variability in a value or range, for example, within 90%, within 95%, or within 99% of a stated value or of a stated limit of a range.

In response to the unmet need, a new method is herein presented that involves a cross-linking mechanism which provides a high strength protein adhesive that does not require extensive synthetic modifications or additions. Although there has been interest in soy protein adhesives, due to renewability and low cost, the majority of these high strength systems require the incorporation of polymer resins. By utilizing the chemistry similar to that in the browning of food, we disclosed herein a method for cross-linking proteins, including as examples soy protein and bovine serum albumin, to increase their adhesive properties. In the presence of free amine groups, ascorbic acid, also known as vitamin C, adducts are formed that lead to the formation of free radicals resulting in protein-protein cross-linking, consistent with Mailard reaction. It should be appreciated that although Mailard reaction is mentioned herein for describing the chemistry, such use is not intended to be limiting as to the type of chemistry that is indicative of the products claimed herein. In addition, although ascorbic acid is mentioned herein, such use is not intended to be limiting. Rather, any reducing agent can be used. Similarly, any polymer can be used in lieu of soy protein. Moreover, any soluble protein (including but not limited to any proteins that are soluble at neutral pH and any proteins that have sufficient amounts of arginine and lysine residues) can be used in place of soy protein. Further, any oxidant can be substituted for the oxygen in air as mentioned in this disclosure as merely one example of the applications of the principles described herein.

One of the cheapest renewable alternatives is the soybean protein. However, methods for creating protein adhesives, including soybean proteins, typically require extensive protein modifications or functionally modified resins, neither of which is currently inexpensive enough to replace formaldehyde-based glues. The new method proposed herein involves a cross-linking mechanism that provides a high strength protein adhesive that does not require extensive synthetic modifications or additions; instead it utilizes the chemistry of Maillard reaction to increase adhesive bonding of the protein. This method can be used to increase the adhesive properties of various protein systems, which can include but are not limited to wheat, casein, and collagen not just soybean and bovine serum albumin. In addition to being a much simpler and environmentally friendly method for creating protein adhesives, this method is very low cost, only requiring the addition of ascorbic acid.

In addition, until the twentieth century, many adhesives were developed from natural resources such as soybean, after which it was almost completely replaced by formaldehyde adhesives. While there are currently many commercial glues available for binding various substrates, most contain either phenol-formaldehyde or urea-formaldehyde resin adhesives. These adhesives emit formaldehyde not just during production, but also in everyday use. As mentioned above, due to carcinogenic effects, the adhesive industry is trying to develop an alternative. To accomplish this, there has been a renewed interest in soy protein adhesives, which has resulted in the development and commercialization of two types of new soy products: soy/phenol-resorcinol-formaldehyde systems and soy meal/flour formaldehyde-free adhesives. Soy adhesives have the potential to replace formaldehyde-based adhesives with environmentally friendly glues, but the methods to produce them are often too costly to realistically replace current adhesives.

Moreover, in addition to being a much simpler and environmentally friendly method for creating soy adhesives, the herein disclosed approach can increase the adhesive properties of various protein systems, especially those with high levels of free amine groups. This single-step process is also very cost effective, with the only additional cost to the protein system being ascorbic acid. This system also does not require any additional purification or processing before use. Furthermore, many adhesives require elevated temperature and pressure to produce high strengths. Utilizing this method, high strength adhesion can be achieved at room temperature and with no additional pressure. Using this soy adhesive will provide the benefits of a strong adhesive that can cure at room temperature, without the negative side effects of formaldehyde.

Described herein is a cost effective method utilizing a type of chemistry similar to that in the browning of food, Maillard reaction, to introduce adhesive properties to proteins. In one embodiment, a method for manufacturing an adhesive compromises adding ascorbic acid to a protein, where the molar ratio of protein to ascorbic acid ranges from about 0.001 to about 100. In another embodiment, a method for increasing adhesive properties of a protein, the method compromises adding ascorbic acid to a protein, where the molar ratio of protein to ascorbic acid ranges from about 0.001 to about 100. In one embodiment, an adhesive is prepared by adding ascorbic acid to a protein, where the molar ratio of protein to ascorbic acid ranges from about 0.001 to about 100. Yet in another embodiment, the protein is a renewable protein. In a preferred embodiment, the protein is soy protein. In another preferred embodiment, the protein is bovine serum albumin. In another embodiment, the protein is a soluble protein. In some embodiments, the adhesive further comprises about 0.01˜10 molar equivalences of ferric salt. In another embodiment, the adhesive further comprises about 0.01˜10 molar equivalences of periodate.

Results and Discussion

Since the proteins chosen vary in both size and structure, each protein was optimized separately on both aluminum and wood adherends. As a starting point, initial testing conditions were determined by a set of quick preliminary tests, including Maillard reaction temperature, pH, time and concentration. These conditions were 25° C. and pH 7 for both proteins, with a concentration and time of 0.05 g/mL and 1 day for soy and 0.30 g/mL and 7 days for BSA. In addition, adhesive tests were cured for 30 minutes at room temperature, followed by 23 hours at 37° C. and cooled for 30 minutes at room temperature prior to mechanical testing. For each parameter studied, the optimal condition was carried on to the following study.

Ascorbic Acid Optimization

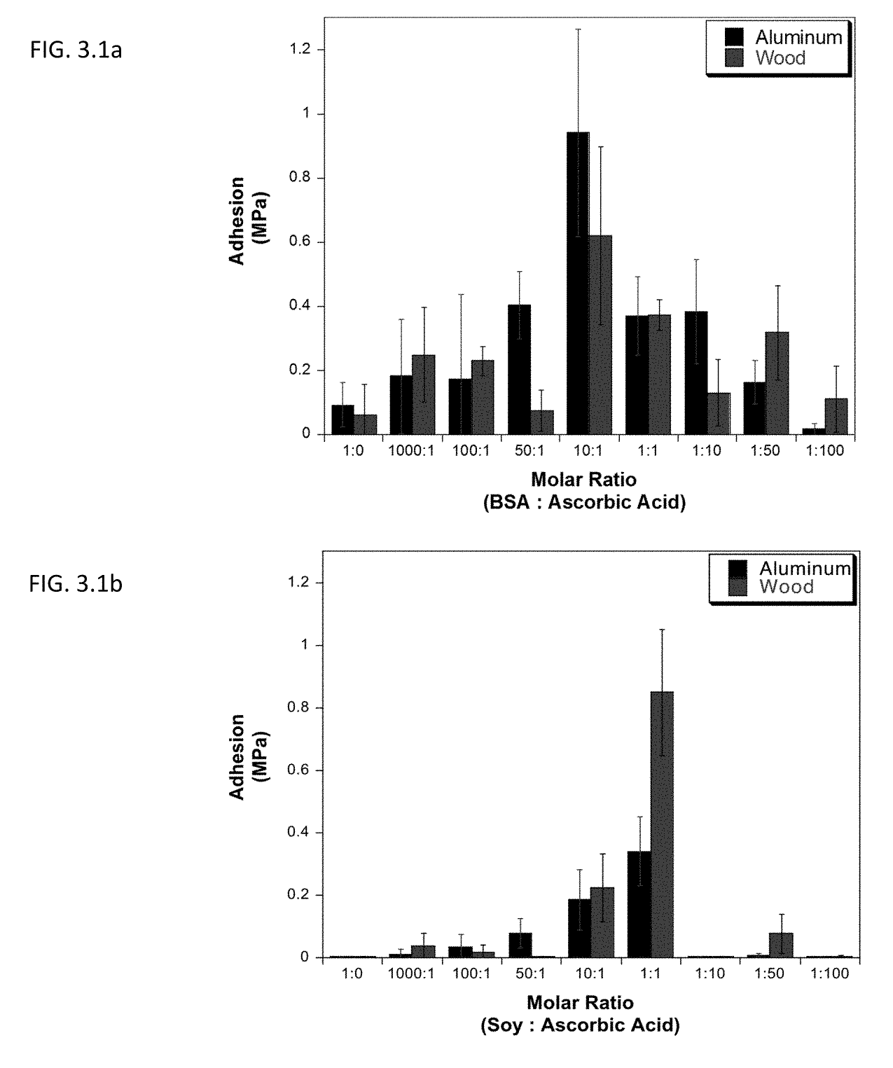

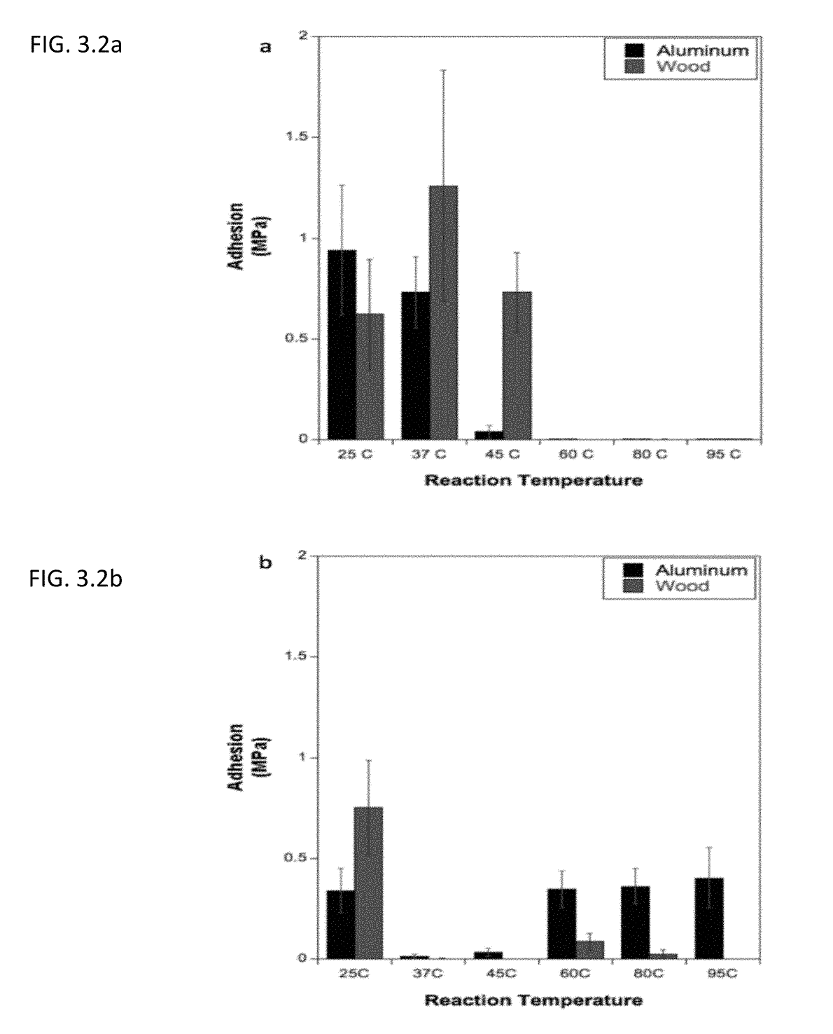

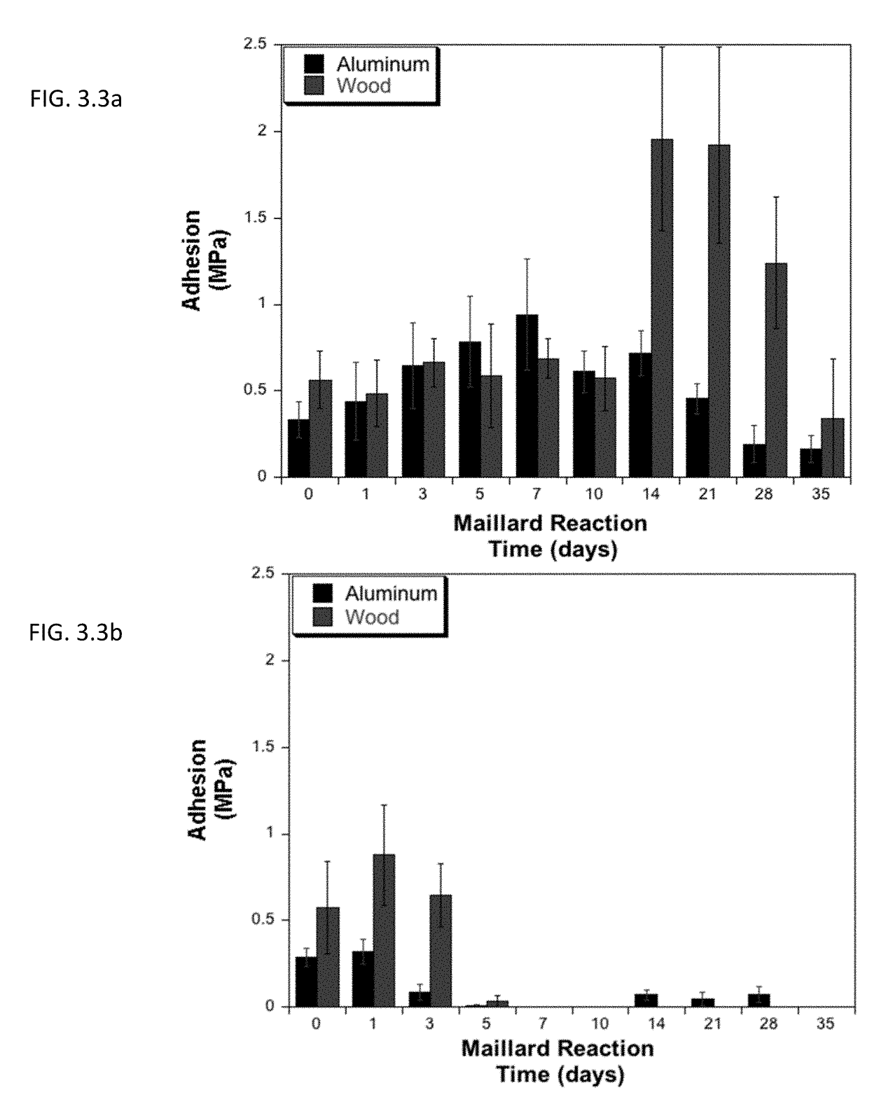

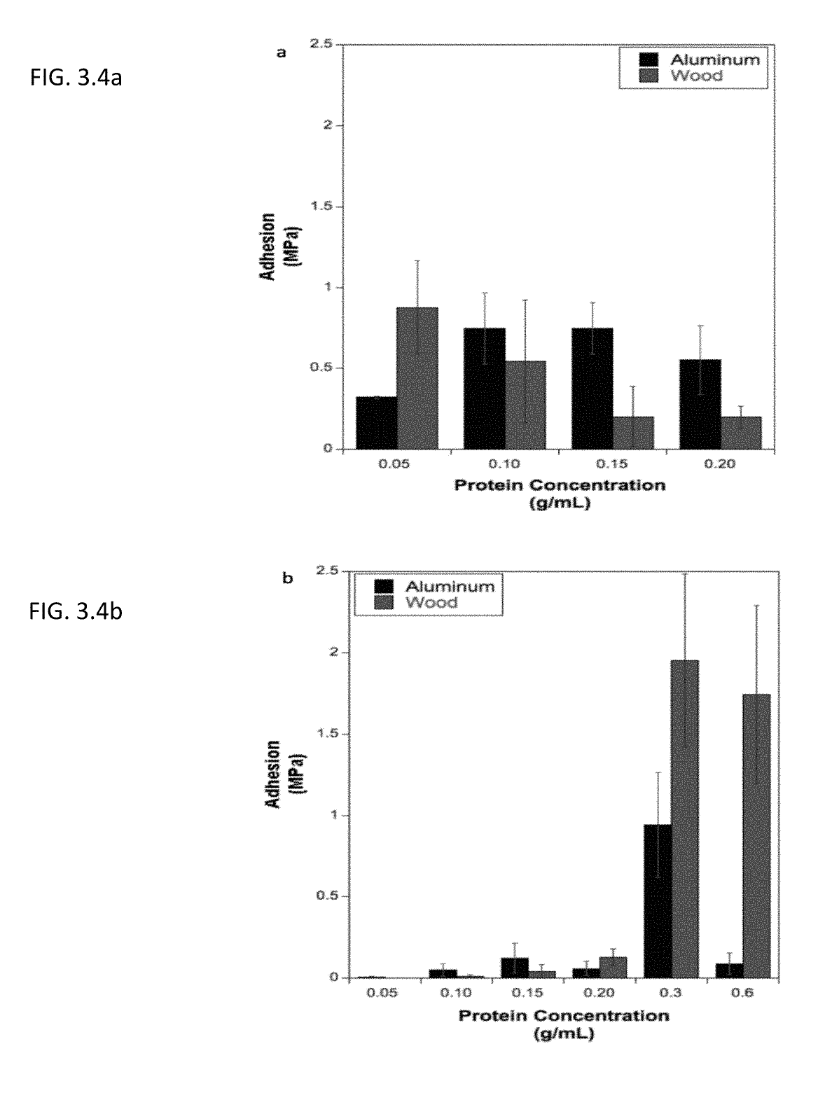

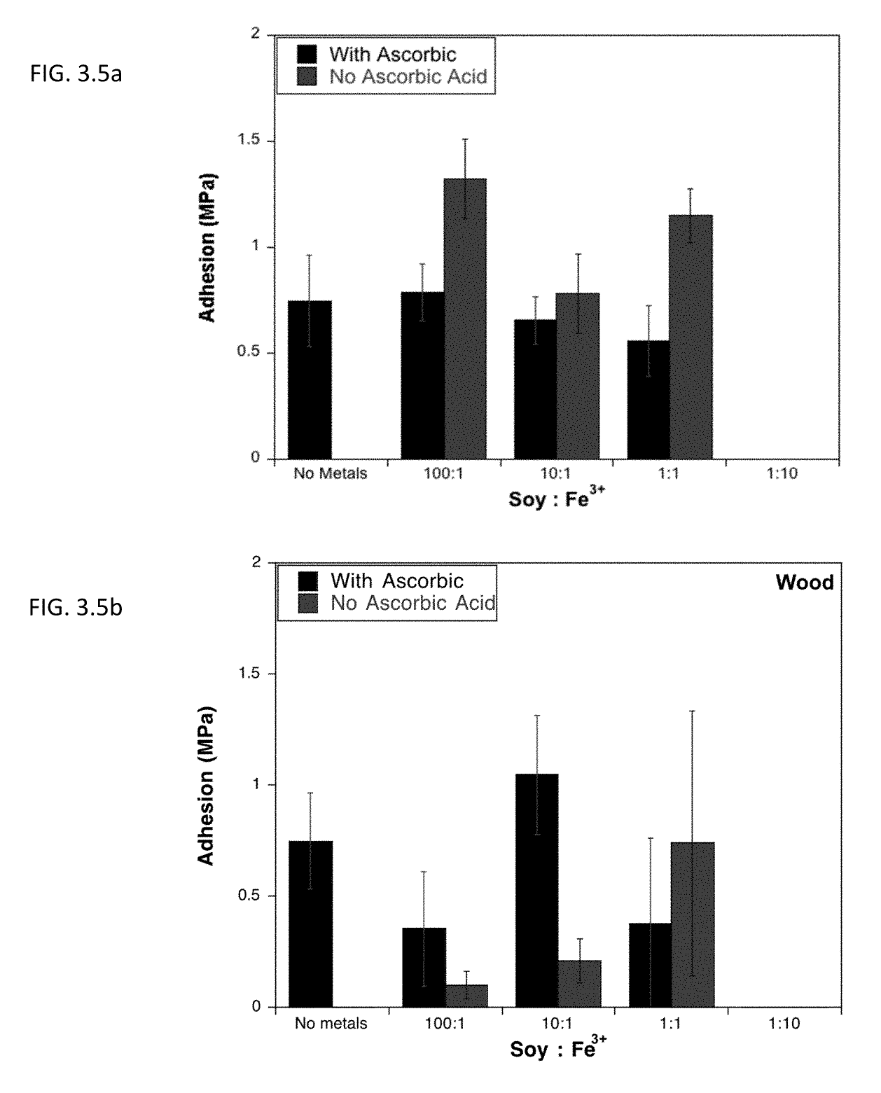

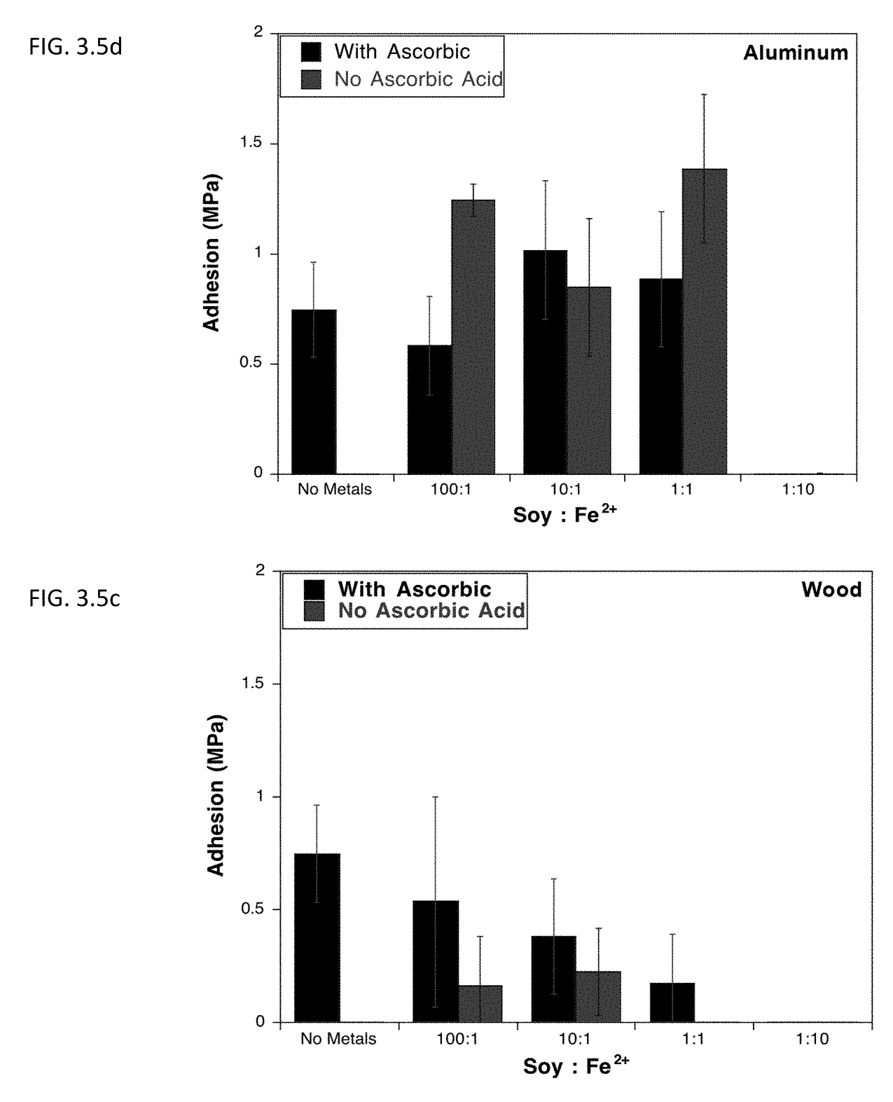

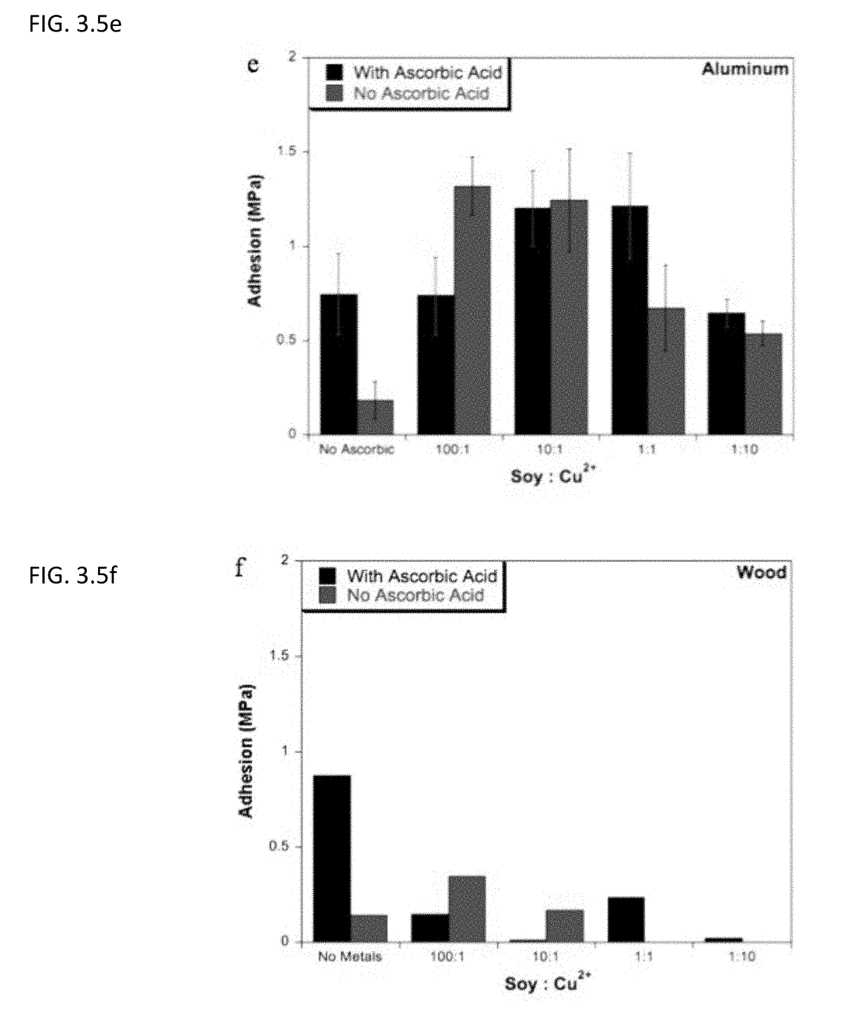

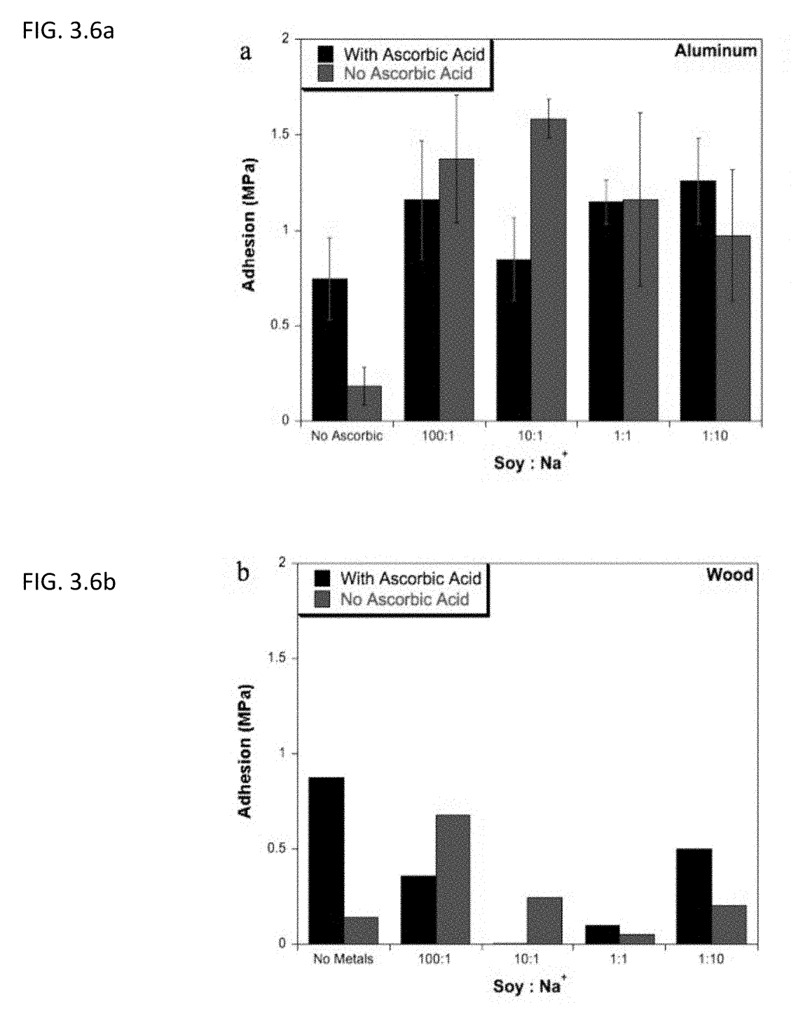

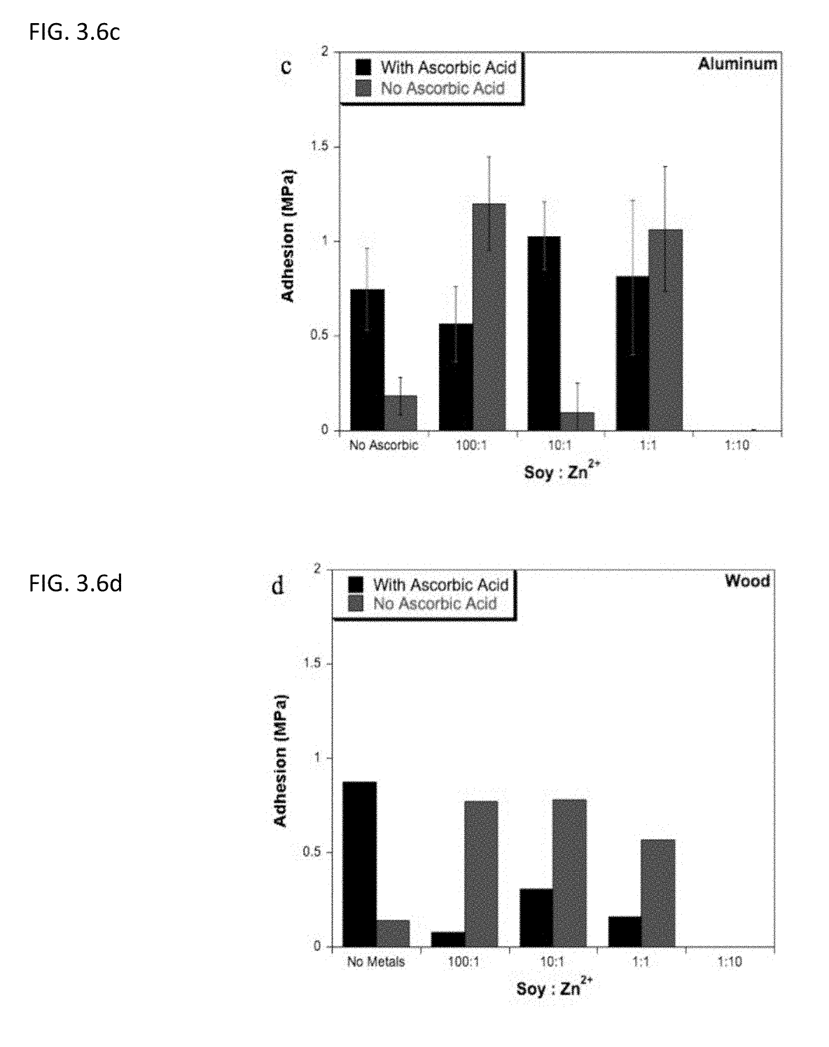

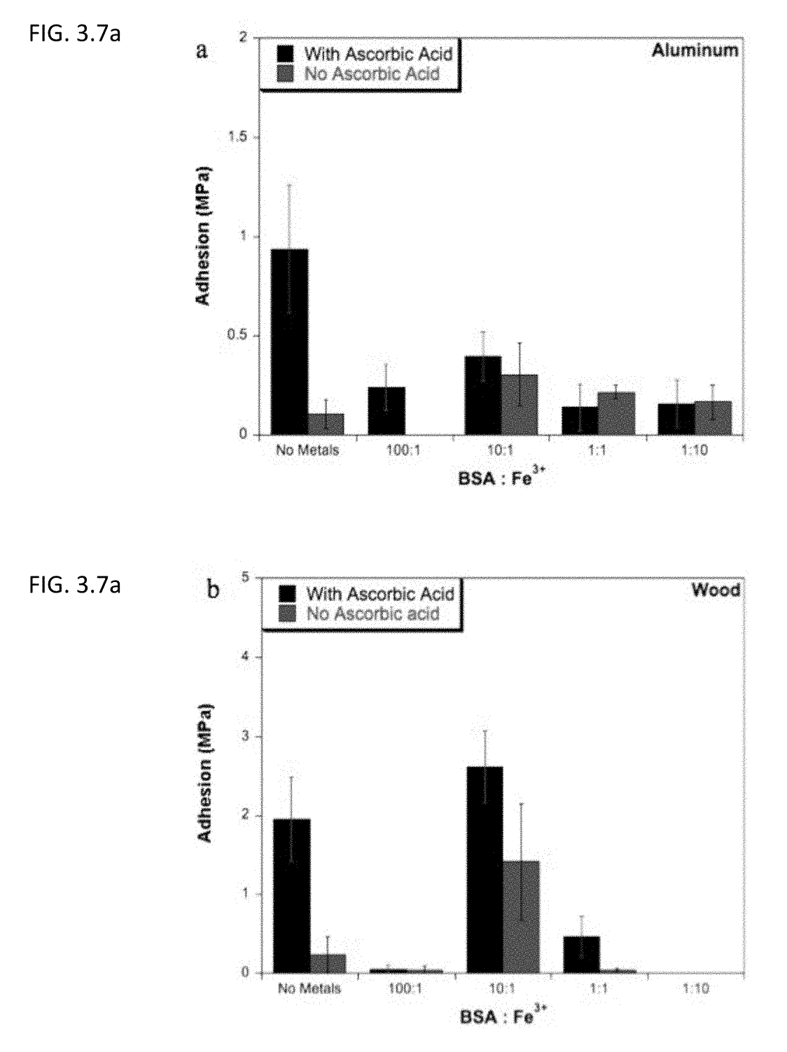

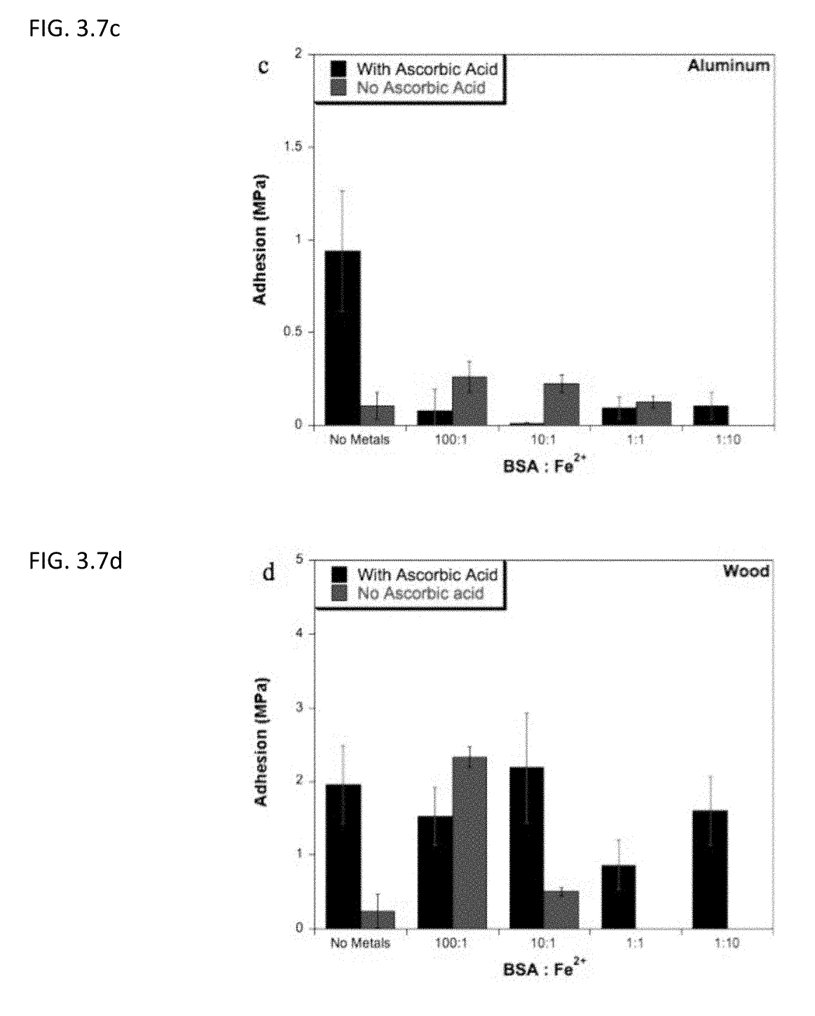

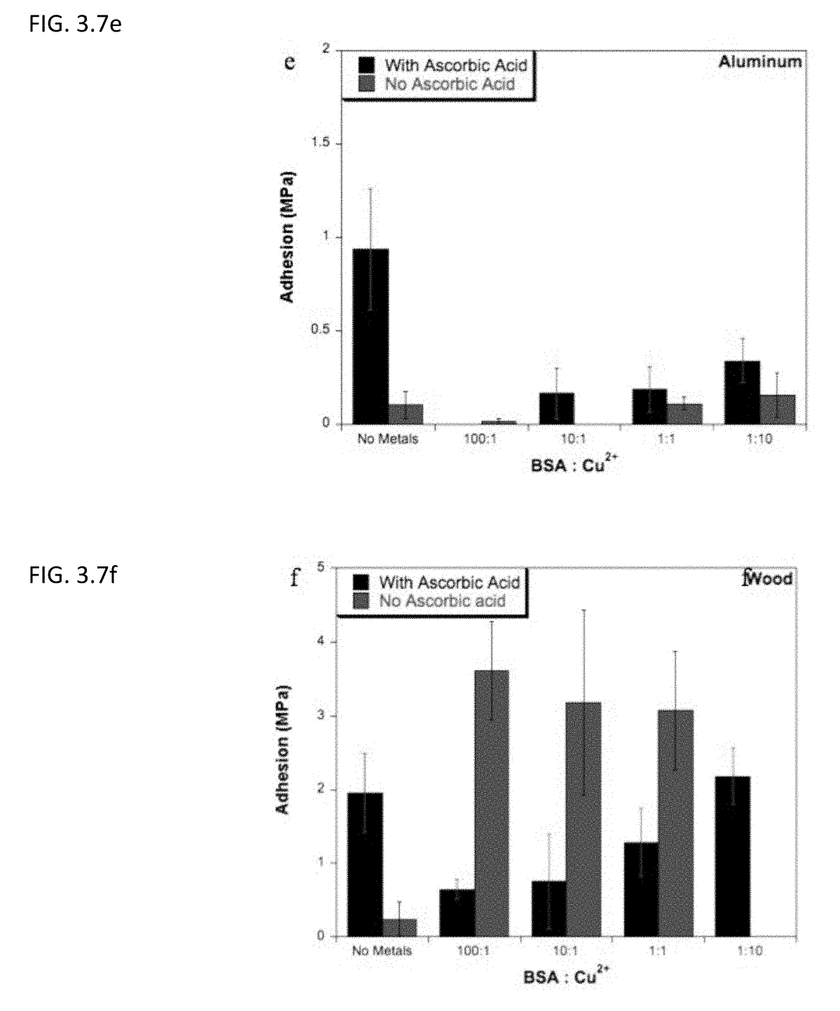

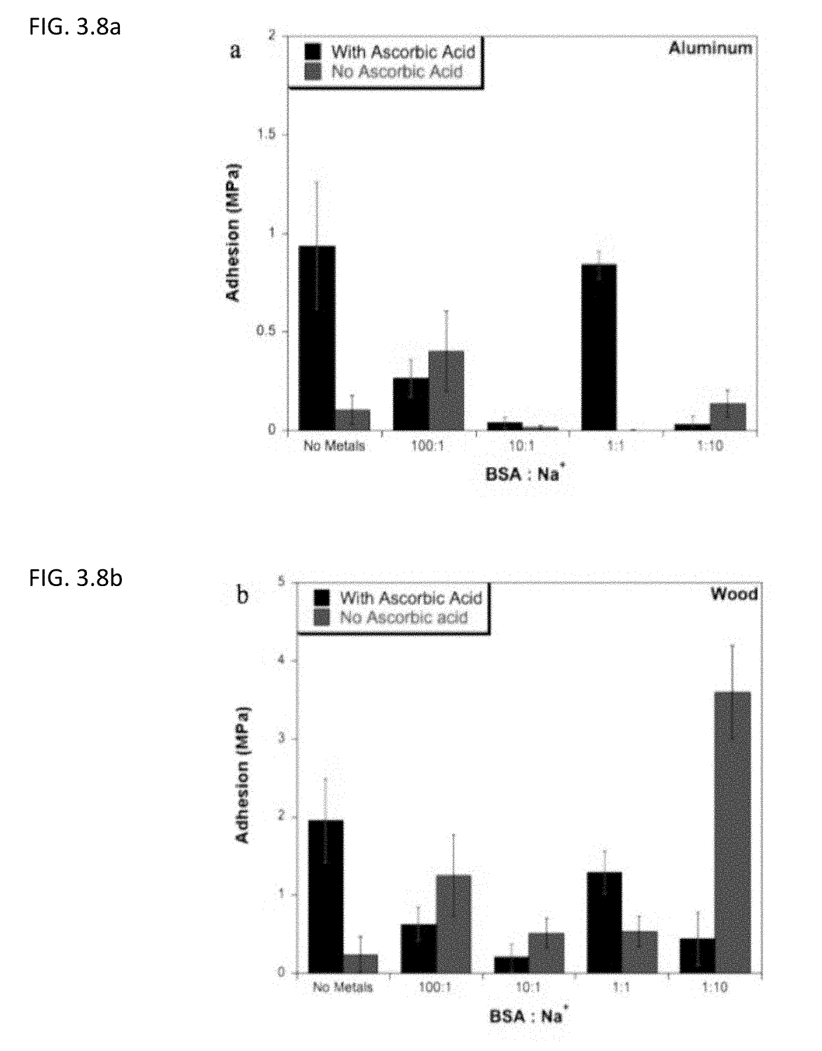

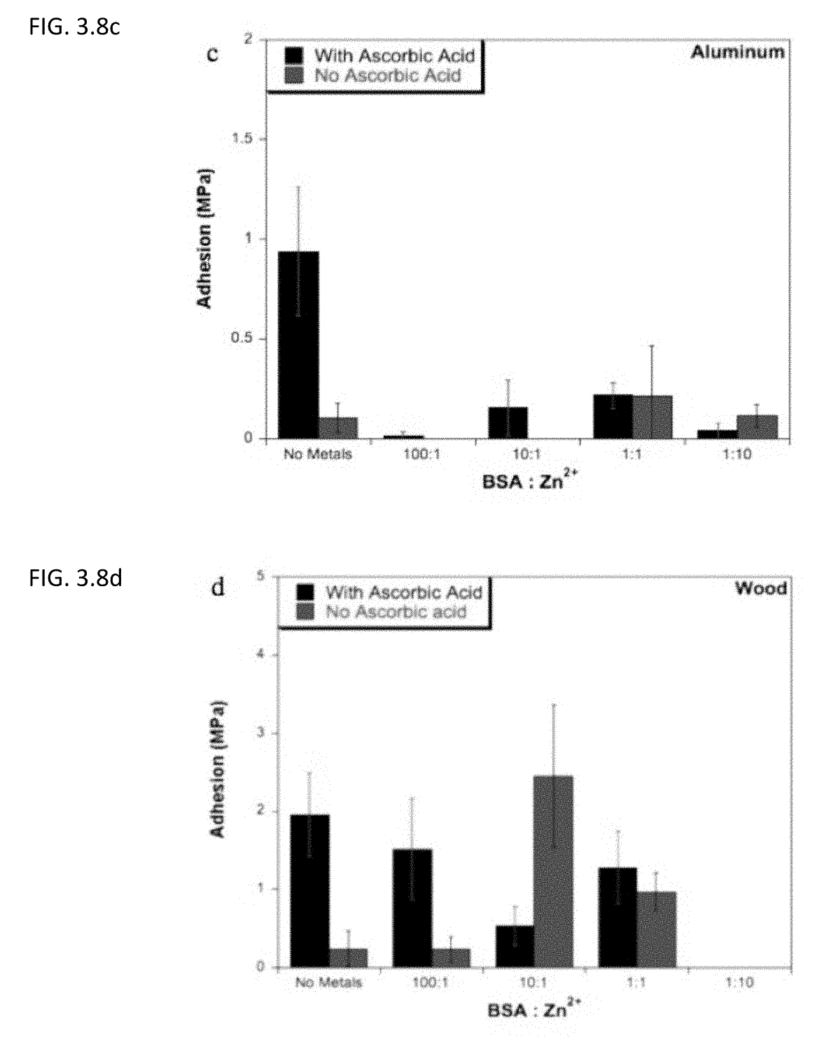

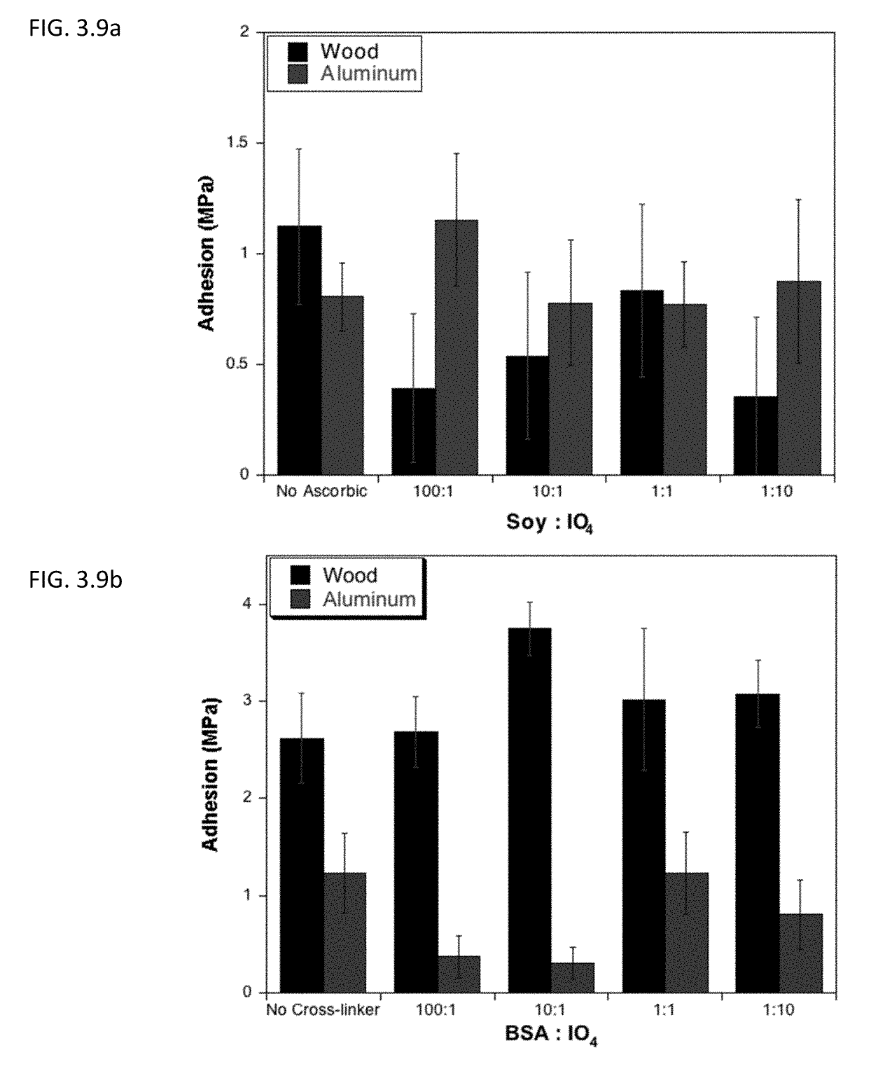

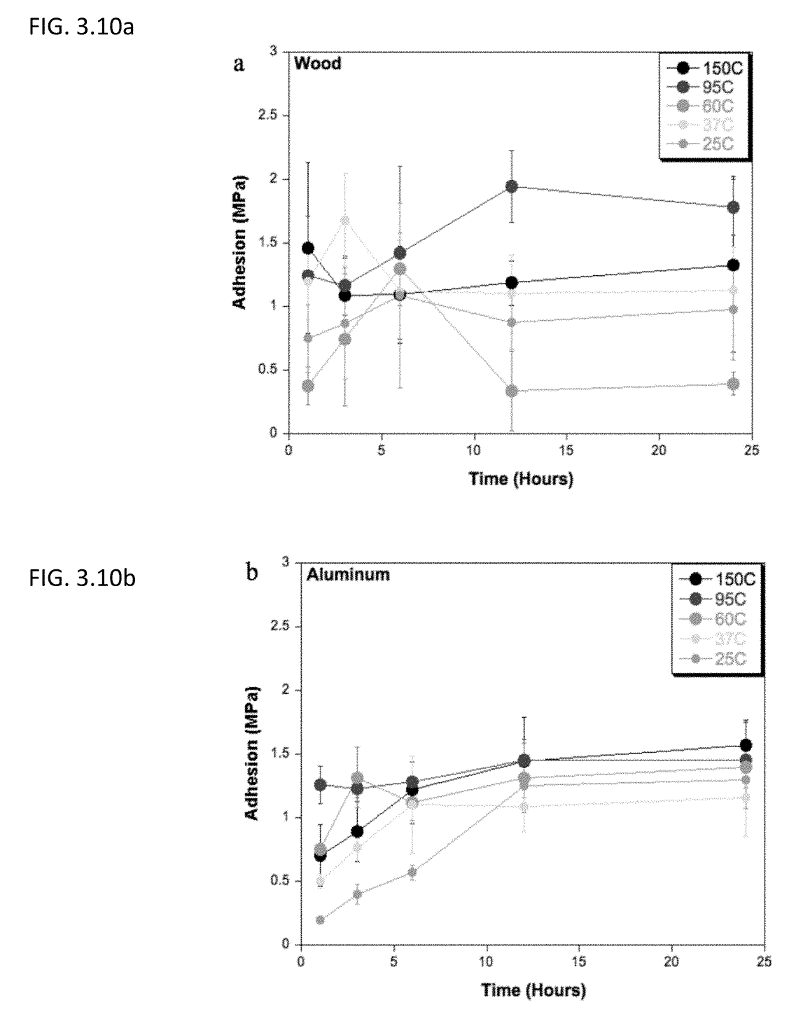

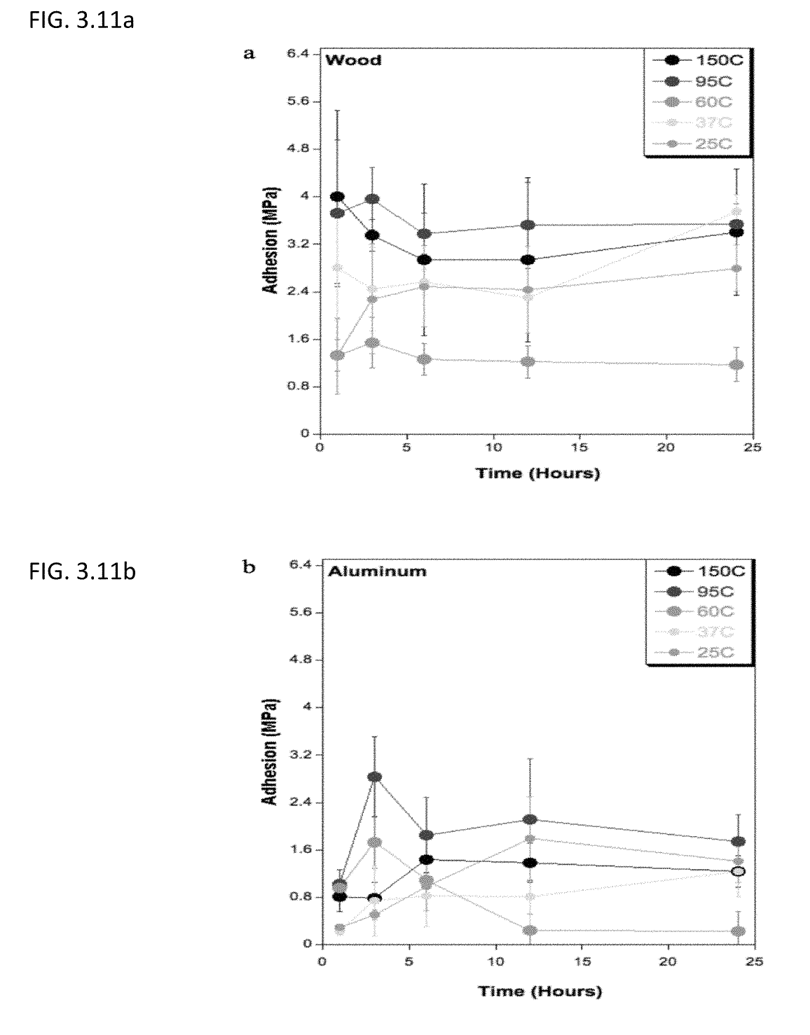

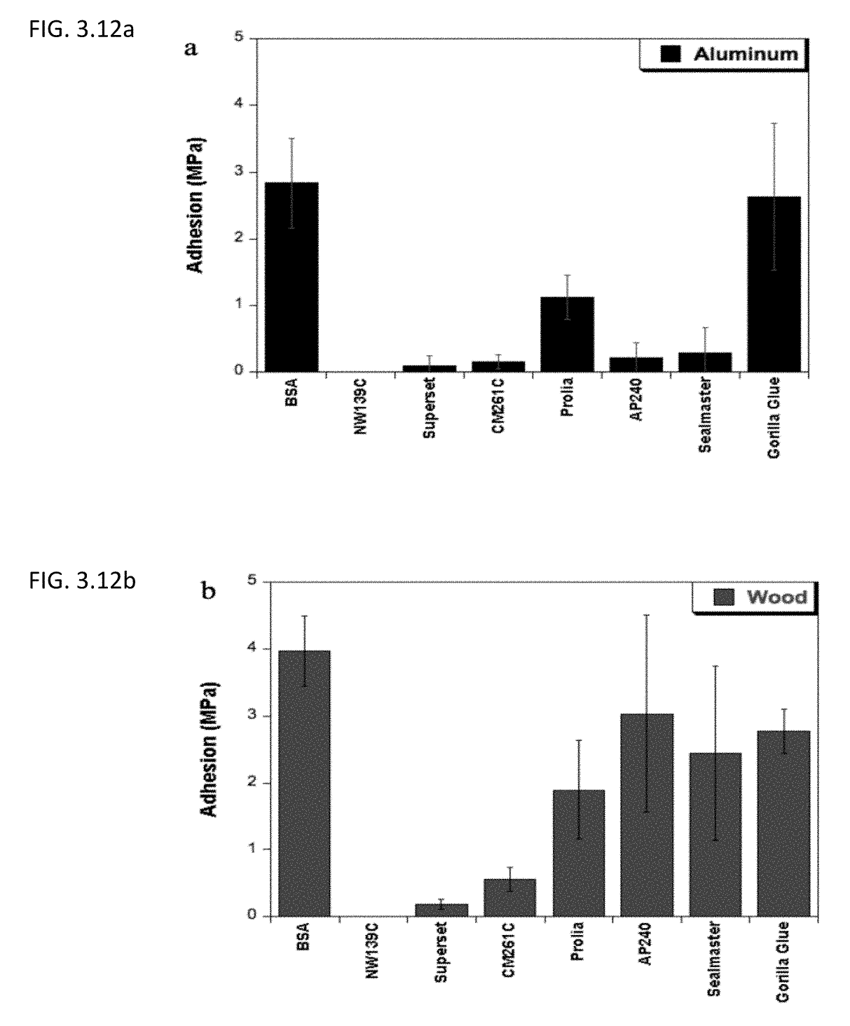

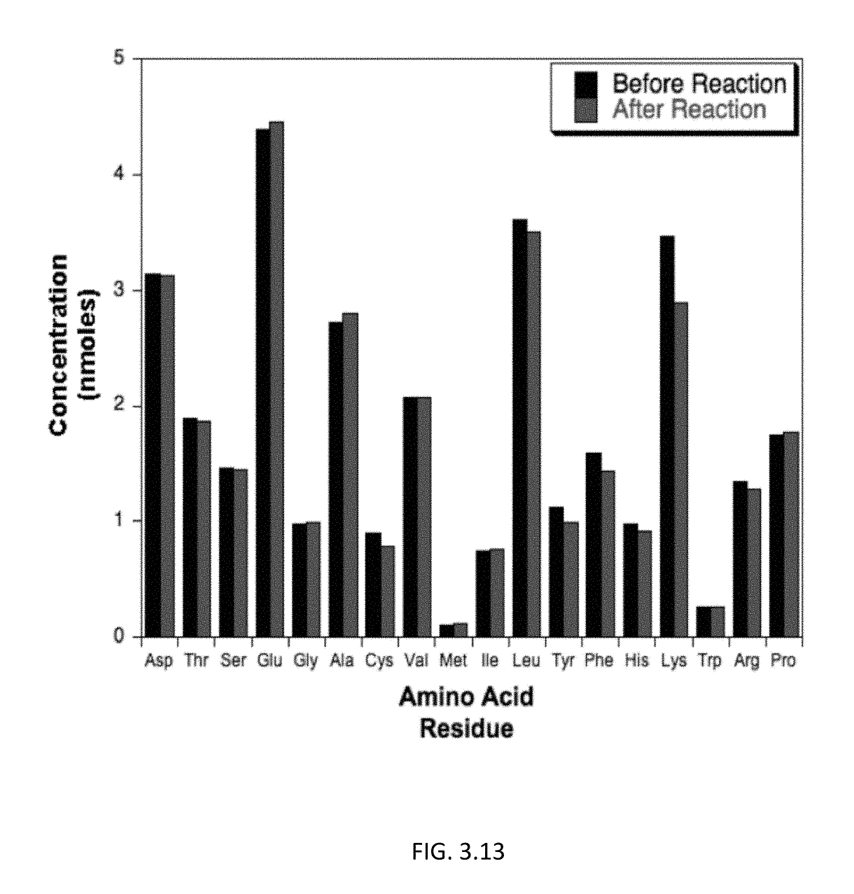

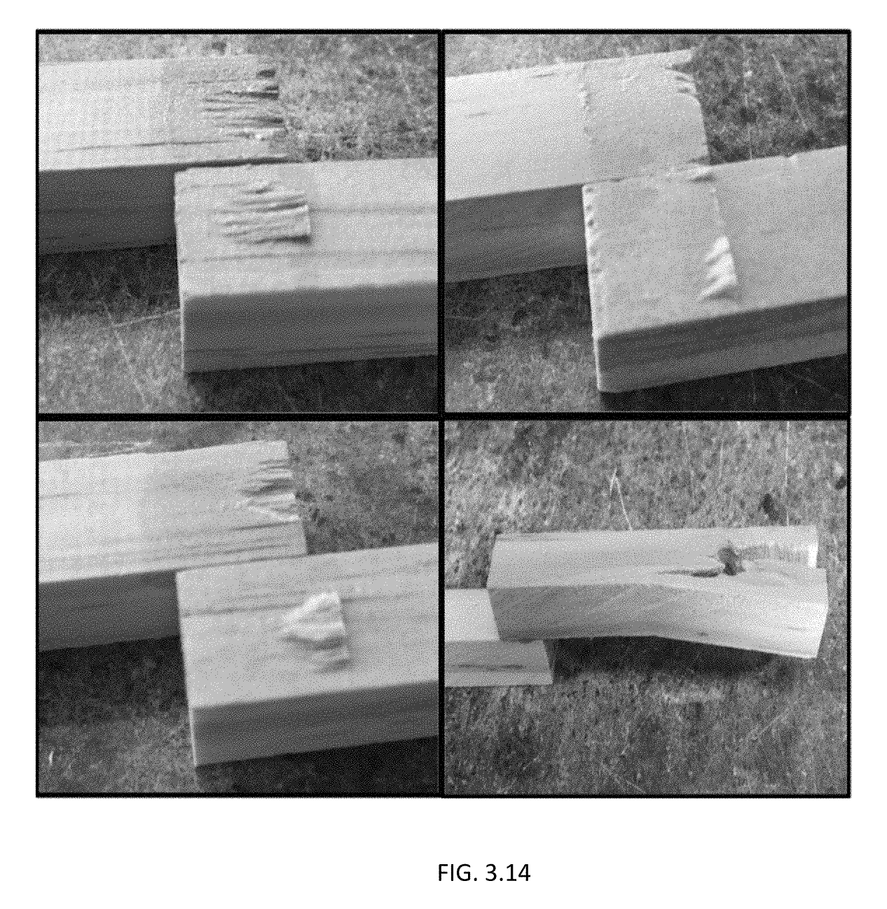

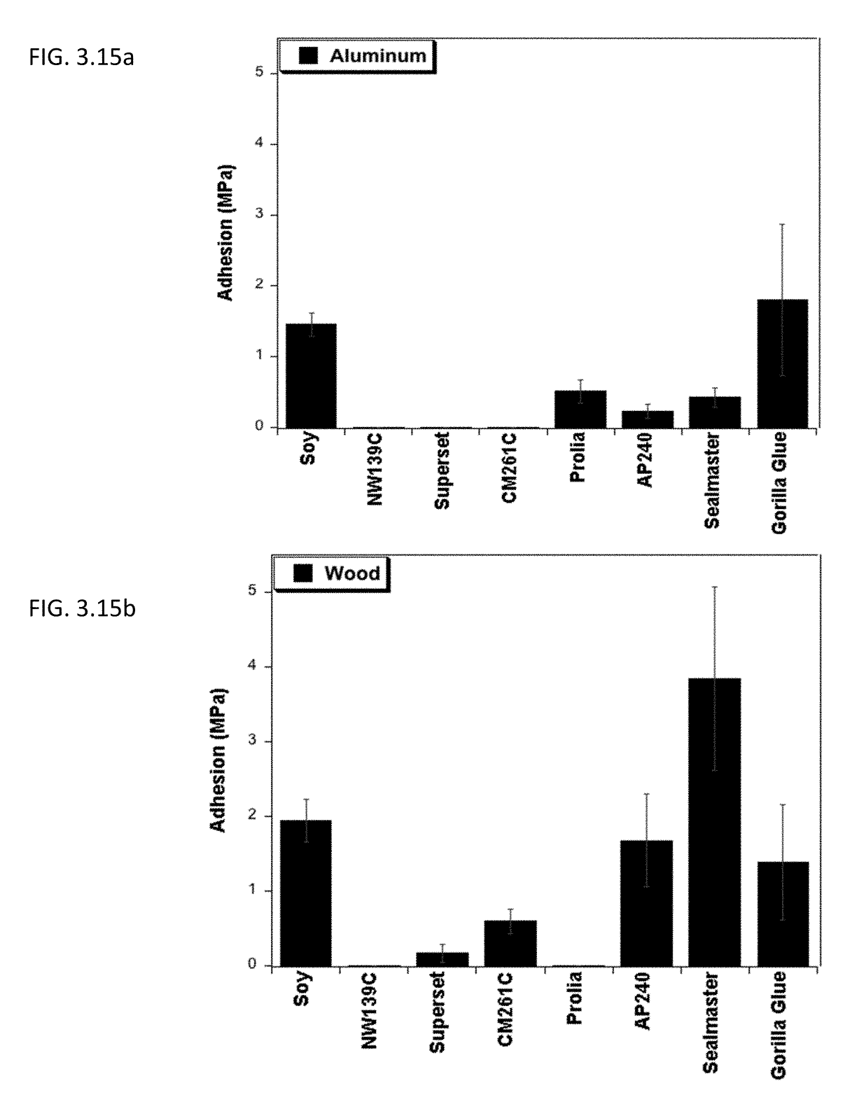

While the exact chemistry of Mailard reaction has been elusive, here we explore how the concentration of ascorbic acid impacts the adhesion of soy protein isolate and BSA. In total, eight different ratios of protein:ascorbic acid (P:AA) were studied. For these studies the concentration of protein stayed constant while that of ascorbic acid varied. A clear indication of the progress of Mailard reaction was the color change of the proteins, from a light cream to a light brown color in soy protein and a light yellow/green to a light/dark brown color in BSA. While this transition in color took time (days), the change was much faster in the BSA reactions, likely due to the improved solubility of the protein compared to soy protein, which is a suspension. Visual analysis of the adhesive material after lap shear testing also reveals information about the protein system. For example, cohesive failure, meaning failure within the bulk of the adhesive, would be indicative of weak intermolecular bonding. By altering the ratio of P:AA, a balance between cohesive and adhesive (surface adhesion) failure was obtained. The addition of ascorbic acid to the protein systems had a major impact on the adhesion on both aluminum and wood substrates. At a 10:1 P:AA ratio, the adhesion of BSA increased to ˜1.0 MPa and ˜0.6 MPa on aluminum and wood respectively (FIG. 3.1a). While soy protein isolate required a 1:1 ratio to achieve ˜0.8 MPa on wood and ˜0.4 MPa on aluminum (FIG. 3.1b). Above these ratios, differences were seen in the protein material after reaction, including increased viscosity and over cross-linking.

Increased viscosity could especially decrease the adhesion on wood substrates due to decreased mechanical interlocking. This feature is essential in wood adhesion. By allowing deeper penetration into the microstructure of the wood, there is an increase in the surface area between the adhesive and the wood, in turn making more durable bonds. These optimal P:AA ratios were used for all further studies.

Reaction pH Optimization

While reaction pH was analyzed, the adhesion for both systems drastically decreased both above and below pH 7. This is likely due to three pH effects: (1) decreased protein solubility, (2) the acidic and basic effects on the adherends themselves, and (3) protonation of the reactive amino group at low pH renders it unreactive. Further reactions were continued at pH 7.

Reaction Temperature Optimization

A range of reaction conditions were explored by examining different temperatures: room temperature (25° C.), physiological temperature (37° C.), and those temperatures corresponding to various levels of protein denaturation in both soy and BSA, including 45° C., 60° C., 80° C. and 95° C. Each sample was subjected to the reaction temperature over the reaction time, 1 day for soy and 7 days for BSA. The results showed that, on both aluminum and wood, BSA adhesion decreased as temperatures rose above 37° C., with the optimum temperatures being 25° C. and 37° C. on aluminum and wood, respectively (FIG. 3.2a). This effect corresponded to an increase in viscosity and crosslinking, decreasing the surface interaction and mechanical interlocking of the protein.

The effect of reaction temperature on the adhesion of soy protein was not as straightforward to analyze. On wood, the only significant adhesion was seen with a reaction temperature of 25° C. However, aluminum showed a decrease in adhesion at 37° C. and 45° C., with ˜0.35 MPa seen for all other temperatures (FIG. 3.2b). The strange decrease in adhesion can be attributed to soy denaturation. Increasing its exposure to heat denatures soy protein, in turn reducing its protein dispersibility index (PDI). Both low and high PDIs give good adhesive bonds with soy protein, while medium PDIs give very poor adhesion. While this effect is only minorly seen on the wood adhesion, it is believed that the more viscous protein at high temperatures has less mechanical interlocking, causing lower adhesion at these temperatures.

Reaction Time Optimization

Wide ranges of reaction times were also explored, from 0-35 days. Soy protein illustrated the greatest increase in adhesion on both substrates with a one-day reaction, with a significant increase seen with no addition reaction time, only the cure time (24 hours). However, BSA needs more time to achieve the optimal amount of Maillard-induced cross-linking, 7 days for aluminum and 14 days for wood, and achieving ˜2 MPa on wood substrates. Above these times for BSA and soy adhesives, the adhesion decreases, likely due to over cross-linking within the bulk of the adhesive, i.e. less adhesion.

Protein Concentration Optimization

As previous optimization has shown, controlling the viscosity of the adhesives can have dramatic effects on the overall adhesion. Concentrations explored ranged from water-like at 0.05 g/mL to paste-like at 0.20 g/mL (soy) and 0.60 g/mL (BSA). For all adhesion testing, the volume of adhesive stayed consistent, meaning for higher concentrations there was more material deposited between the adherends. Optimal conditions were determined to be 0.10 g/mL on aluminum and 0.05 g/mL on wood for soy protein and 0.30 g/mL for BSA on both substrates (FIGS. 3.4a and 3.4b).

Metal Induced Effects on Millard Reaction

Also explored was the effect of metal ions, such as Fe³⁺, Fe²⁺, Cu²⁺, Na⁺, and Zn²⁺ on the Maillard-induced adhesion. These ions have been seen to accelerate denaturation, stimulate the oxidation of Amadori compounds and the degradation of protein complexes, and alter the solubility properties of the proteins. Chemical mechanism for the incorporation of metal ions into the browning products of proteins is unclear due to the complexity and the high variability of Mailard reaction. Free metal ions can have an oxidative and reductive influence on Mailard reaction. At certain concentrations metal ions can promote the browning reaction through the oxidation of Amadori compounds. However at higher concentrations, chelation of these metal ions by carboxyl and amino groups slows Mailard reaction. The incorporation of metal ions alone has also been seen to induce crosslinking in proteins through radical formation. This effect can be seen with the incorporation of metal ions into the protein systems being investigated.

While metals alone were seen to dramatically increase protein adhesion in soy, in the presence of ascorbic acid there was a decrease in adhesion, with the exception of the Soy to Fe³⁺ ratio of 10:1, increasing the adhesion by ˜0.2 MPa. Therefore, further reactions with soy protein were done using no metals on aluminum and Soy to Fe³⁺ (10:1) on wood.

The incorporation of metals into the BSA system was much clearer, with almost all metals at high or low concentrations and with or without ascorbic acid decreased adhesion. Similar to soy protein, Fe³⁺ (10:1) increased protein adhesion on wood by >0.5 MPa. Therefore, for further studies, no metals were incorporated into reactions for aluminum adhesion, while Fe³⁺ (10:1) was added to reactions for wood adhesion.

Cross-Linkers Optimization

In addition to examining oxidizing metal ions, here we explore how a nonmetallic oxidant, sodium periodate (NaIO₄) impacts the adhesion of the protein systems, potentially using the cross-linker to “fine tune” the cross-linking within the bulk of the protein adhesives. While there was no clear indication of oxidation through a color change, there were noticeable changes in the failure mode on the aluminum adherends. An increased NaIO₄ concentration resulted in increased adhesive failure indicated by the protein debonding from the substrate, often seen in over cross-linked samples.

The addition of the cross-linking agent periodate had a relatively large impact on adhesion. While periodate decreased the soy protein adhesion on wood, it was able to increase the adhesion on aluminum by ˜0.35 MPa with a soy to periodate ratio of 10:1. This ratio in the BSA adhesive was able to increase wood adhesion by ˜1.0 MPa to 3.75 MPa.

Cure Time and Temperature Optimization

A range of curing conditions were explored by examining different temperature: room temperature (25° C.), physiological temperature (37° C.), a high temperature (150° C.), and those temperatures corresponding to various levels of protein denaturation in both soy and BSA, including 60° C. and 95° C. Each sample was overlapped, a weight was applied for 60 seconds, the weight was removed and the sample was immediately subjected to its cure temperature. After curing for the selected time, samples were removed from the heat source and allowed to cool for ˜3 minutes prior to testing. Results showed that finding a balance between cure time and temperature can greatly improve adhesion strength. While the solvent system in this case is water, even temperatures as low as 25° C. were able to dry within three hours, producing respectable adhesion strength with both BSA (FIGS. 3.9a and 3.9b) and soy protein isolate (FIGS. 3.10a and 3.10b), while small amounts of residual solvent may still be present.

Stronger bonding and more brittle adhesives were seen at higher temperature and longer cure times. The strongest adhesion achieved for the soy protein adhesive was 1.95 MPa and 1.45 MPa, on wood and aluminum respectively, at 95° C. and 12 hours. While the BSA adhesive system also has an optimum cure temperature of 95° C., it requires less time to reach its optimum cure time, three hours. After only a short cure time, the BSA adhesive is able to achieve strengths of 4.0 MPa and 2.8 MPa on wood and aluminum respectively. The BSA adhesive is also able to achieve a strength of 3.7 MPa in only one hour at 95° C. The final optimal adhesion conditions are seen in FIGS. 3.12a and 3.12b.

Comparison to Commercial and Protein-Based Glues

When compared to commercial adhesives, the Maillard-based protein adhesives were able to achieve strengths comparable, and in some cases higher than that of even Gorilla Glue. The majority of the commercial adhesives compared were protein-based glues from LD Davis Industries (NW139C, Superset, CM261C,) and Cargill (Prolia), in addition to starch-based glues from Grain Processing Corporation (Sealmaster P30L) and LD Davis Industries (AP240). Many of these adhesives have been optimized over decades while this protein-based adhesive is only in the early stages of development.

Bonding strengths of the BSA glue is similar to that of Gorilla Glue on aluminum, while on pine wood the BSA adhesive is over 1.0 MPa greater in strength (FIGS. 3.12a and 3.12b). This is likely due to its ability to flow into the wood and achieve greater mechanical interlocking. This strength was great enough to, in some cases, break the wood instead of breaking apart at the adhesive bond (FIG. 3.14).

The soy protein adhesive did not perform as well compared to adhesives (FIGS. 3.15a and 3.15b). While on aluminum it was higher than the majority of the commercial glues, on wood it was ˜1.8 MPa lower than that of the starch-based glue, Sealmaster.

Amino Acid Analysis

Samples were sent to the Molecular Structure Facility at the University of California, Davis for analysis. The changes in amino acid composition were analyzed before and after Mailard reaction. After which the only significant change was seen in the levels of lysine residues, equating to a 10-residue loss (FIG. 3.13). While the exact mechanism of cross-linking is elusive, the loss of lysine residues is consistent with Mailard reaction. There is however only a 1-residue loss in arginine levels, where more changes would expect to be seen.

### Example 1

An optimized condition for manufacturing adhesive with soy protein isolate for use on aluminum substrates: molar ratio of protein to ascorbic acid 1:1; reaction pH 7.0; reaction temperature 25° C.; reaction time 1 day; protein concentration 0.1 gram/mL; metal ions none; periodate cross-linker (protein:periodate) 100:1; cure time 12 hours; cure temperature 95° C. The adhesive so prepared achieves a maximum adhesion 1.45±0.17 MPa.

### Example 2

An optimized condition for manufacturing adhesive with soy protein isolate for use on wood substrates: molar ratio of protein to ascorbic acid 1:1; reaction pH 7.0; reaction temperature 25° C.; reaction time 1 day; protein concentration 0.05 gram/mL; metal ions (protein:ferric salt) 10:1; periodate cross-linker none; cure time 12 hours; cure temperature 95° C. The adhesive so prepared achieves a maximum adhesion 1.95±0.28 MPa.

### Example 3

An optimized condition for manufacturing adhesive with BSA for use on aluminum substrates: molar ratio of protein to ascorbic acid 10:1; reaction pH 7.0; reaction temperature 25° C.; reaction time 7 day; protein concentration 0.3 gram/mL; metal ions none; periodate cross-linker none; cure time 3 hours; cure temperature 95° C. The adhesive so prepared achieves a maximum adhesion 2.83±0.68 MPa.

### Example 4

An optimized condition for manufacturing adhesive with BSA for use on wood substrates: molar ratio of protein to ascorbic acid 10:1; reaction pH 7.0; reaction temperature 37° C.; reaction time 14 day; protein concentration 0.3 gram/mL; metal ions (protein:ferric salt) 10:1; periodate cross-linker (protein:periodate) 10:1; cure time 3 hours; cure temperature 95° C. The adhesive so prepared achieves a maximum adhesion 3.97±0.52 MPa.

Experimental

Maillard Reaction Conditions

While various reaction conditions were altered to achieve the highest adhesion on both aluminum and wood, there were conditions that were held constant and are discussed here. All reacts were completed in 50 mL falcon tubes, with the protein dissolved in 3 mL of double distilled, deionized water. These falcon tubes were then para-filmed shut and shaken on their side at ˜150 rpm in a New Brunswick Scientific incubator.

Amino Acid Analysis

Official amino acid analysis was completed the Molecular Structure Facility at the University of California, Davis. Hydrolysis was completed at 110° C. over a period of 24 hours with the addition of 200 μL, 2 M HCl with 1% phenol. This facility utilizes Hitachi amino acid analyzers, which separate amino acid residues via ion-exchange chromatography. This is followed by a ninhydrin reaction and detection system.

Single Lap Joint Shear Testing

All adhesion testing was carried out using aluminum and pine wood substrates. Sheets of aluminum, 6061-T6 (Farmer's Copper), were cut into adherends, 8.89 cm×1.27 cm×0.318 cm, and cleaned following the ASTM D2651-01 standard method. Common pine, purchased from the local hardware store, was cut to approximately 8.89 cm×1.27 cm×1.27 cm substrates and the uncut sides were used without any further surface modification.

Lap shear testing of protein samples on aluminum was done generally as follows. The protein solution (7.5 μL) was spread onto two adherends using a micropipette, overlapped (1.2×1.2 cm) in the single lap-shear arrangement, and pressure applied with 55 g weights. Lap shear testing on wood substrates was performed the same way with the exception of the amount of material deposited, 45 μL vs 7.5 μL. In most cases, the adherends are allowed to set for 30 minute, after which the weights are removed and the adherends are allowed to cure at 37° C. for 23 hrs. Following a final 30 minute set, each trial was tested using an Instron 5544 Material Testing System with a 2,000 N load cell.

In order to calculate the adhesion strength (MPa), the maximum load (N) at failure was divided by the substrate overlap area (m²). For most studies, a data set of at least 10 trials was collected. The average of these data sets and errors at 90% confidence intervals are reported.

Those skilled in the art will recognize that numerous modifications can be made to the specific implementations described above. The implementations should not be limited to the particular limitations described. Other implementations may be possible.

1. An adhesive comprising a protein and a reducing agent, wherein the molar ratio of said protein to said reducing agent ranges from about 0.001 to about 100.

2. The adhesive of claim 1, wherein the protein is a renewable protein.

3. The adhesive of claim 2, wherein the renewable protein is soy protein or serum albumin.

4. (canceled)

5. The adhesive of claim 1, wherein the protein is a soluble protein.

6. The adhesive of claim 1, further comprising about 0.01˜10 molar equivalence of ferric.

7. The adhesive of claim 1, further comprising about 0.01˜10 molar equivalence of periodate.

8. A method for manufacturing an adhesive comprising adding a reducing agent to a protein, wherein the molar ratio of said protein to said reducing agent ranges from about 0.001 to about 100.

9. (canceled)

10. The method of claim 8, wherein the protein is a soluble protein.

11. The method of claim 8, wherein the protein is a renewable protein.

12. The method of claim 11, wherein the renewable protein is soy protein or serum albumin.

13. (canceled)

14. An adhesive of claim 8.

15. A method for increasing adhesive properties of a protein, comprising adding a reducing agent to the protein, wherein the molar ratio of said protein to said reducing agent ranges from about 0.001 to about 100.

16. (canceled)

17. The method of claim 15, wherein the protein is a renewable protein.

18. (canceled)

19. The method of claim 17, wherein the renewable protein is soybean protein or serum albumin.

20. The method of claim 15, wherein the protein is a soluble protein.

21. An adhesive of claim 15.

22. The adhesive of claim 1, wherein said reducing agent is ascorbic acid.

23. The method of claim 8, wherein said reducing agent is ascorbic acid.

24. The method of claim 8, further comprising a step of adding about 0.01˜10 molar equivalence of an oxidant.

25. The method of claim 15, wherein said reducing agent is ascorbic acid.
